(19) United States
(12) Patent Application Publication
(10) Pub. No.: US 2011/0306332 A1
(43) Pub. Date: Dec. 15, 2011

(54) Method and Apparatus For Requesting A Connection In A Cellular Communication Network

(76) Inventor: Ian Macpherson, Berkshire (GB)

(21) Appl. No.: 13/062,477

(22) PCT Filed: Jul. 17, 2009
(86) PCT No.: PCT/EP09/59239

§ 371 Date: Sep. 1, 2011

(30) Foreign Application Priority Data
Sep. 4, 2008 (GB) 0816142.4

(51) Int. Cl. H04W 88/00

(52) U.S. Cl. 455/419

(57) ABSTRACT

A network element comprises a management logic module and a translator service logic module arranged to be operably coupled to each of: a communication access point via a first communication link, an auto configuration server (ACS) logic module via a second communication link, and an Element Management System (EMS) associated with the communication access point via a third communication link. The translator service logic module is arranged to receive a connection request from the ACS logic module and transmit the connection request to the communication access point via the first communication link.

### FIELD OF THE INVENTION

The field of the invention relates to a method and apparatus for requesting a connection in a cellular communication network, and more particularly to a method and apparatus for requesting a connection in a femto cell communication network.

### BACKGROUND OF THE INVENTION

Wireless communication systems, such as the 3^{rd} Generation (3G) of mobile telephone standards and technology, are well known. An example of such 3G standards and technology is the Universal Mobile Telecommunications System (UMTS), developed by the 3^{rd} Generation Partnership Project (3GPP) (www.3Gpp.orq).

Typically, wireless subscriber communication units, or User Equipment (UE) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network.

The 3^{rd} generation of wireless communications has been developed for macro-cell mobile phone communications. Such macro cells utilise high power base stations (NodeBs in 3GPP parlance) to communicate with UEs within a relatively large coverage area.

Lower power (and therefore smaller coverage area) femto cells or pico-cells are a recent development within the field of wireless cellular communication systems. Femto cells or pico-cells (with the term femto cells being used hereafter to encompass pico-cells or similar) are effectively communication coverage areas supported by low power base stations (otherwise referred to as Access Points (APs)). These femto cells are intended to be able to be piggy-backed onto the more widely used macro-cellular network and support communications to UEs in a restricted, for example ‘in-building’, environment.

In this regard, a femto cell that is intended to support communications according to the 3GPP standard will hereinafter be referred to as a 3G femto cell. Similarly, an access controller intended to support communications with a low power base station in a femto cell according to the 3GPP standard will hereinafter be referred to as a 3^{rd} generation access controller (3G AC). Similarly, an Access Point intended to support communications in a femto cell according to the 3GPP standard will hereinafter be referred to as a 3^{rd} Generation Access Point (3G AP).

In a 3G femto cell deployment, each 3G AC is arranged to support a large set of 3G APs. Each 3G AP is configured to associate with a specific 3G AC, and each 3G AC must be specifically provisioned to authorize and service each 3G AP.

Typical applications for such 3G femto cell APs include, by way of example, residential and commercial (e.g. office) locations, ‘hotspots’, etc, whereby an AP can be connected to a core network via, for example, the Internet using a broadband connection or the like. In this manner, femto cells can be provided in a simple, scalable deployment in specific in-building locations where, for example, network congestion at the macro-cell level may be problematic.

Typically, each 3G femto cell AP is owned by a member of the public, as opposed to a Network Operator, and the owner of the 3G AP pays for the network resources, such as Digital Subscriber Line (DSL) bandwidth, used through the femto cell.

It is known that a consequence of the introduction of numerous femto cells is a need to provision the 3G AP with various useful parameters that enable it to find suitable information to enable it to transmit and work in harmony with the rest of the macro cellular network. In this regard, the initial provisioning information of the 3G AP should allow the 3G AP to search a provided range/selection of frequencies, primary scrambling codes and transmit powers in order to find values that optimise its integration into, and minimise interference it causes, to the macro-cellular network.

Referring now to FIG. 1A and FIG. 1B, a known proposed architecture 100 for provisioning a 3G AC and a 3G AP in a femto cell network, is illustrated. The architecture 100 comprises a femto cell AP, for example a 3G AP, 105 that is operably coupled to a managed residential gateway, for example a 3G AC, 125 over a local area network (LAN) 120. The managed residential gateway 125 is operably coupled to an auto configuration server (ACS) 135 via a regional broadband network 130. The ACS 135 is arranged to independently provision, and receive provision parameter confirmation, the managed residential gateway 125 via southbound interface 140. The ACS 135 is also operably coupled to a service configuration manager 145 via a northbound interface.

Referring now to FIG. 1B, the operation of the known architecture 150 is illustrated in more detail. Here, a Network Operator Management System 155 forwards configuration (provisioning) information to the femto cell management system 135. The femto cell management system 135 is operably coupled to respective logical entities a femto cell gateway (or access controller) management system (FGW-MS) 160 and a femto cell access point management system (FAP-MS) 165. The FGW-MS 160 is arranged to independently configure the femto cell gateway 125 via interface Fg 170. The FAP-MS 166 is arranged to independently configure the femto cell AP 105 via interface Fm 175.

The TR-069 Customer Premises Equipment (CPE) WAN Management Protocol (CWMP) Specification requires the ability of an ACS Service to address a Customer Premises Equipment (CPE) behind a Firewall/Network Address Translator (NAT) Gateway and request Connection to the ACS. NAT traversal is a general known term for techniques to establish and maintain Transport Communication Protocol (TCP)/Internet Protocol (IP) network connections that traverse NAT gateways. These techniques are typically required for client-to-client networking applications, especially peer-to-peer and Voice-over-IP (VoIP) deployments. It is known that many techniques exist, but no technique works in every situation, since NAT behaviour is not standardized. Of these, many techniques require assistance from a computer server at a publicly-routable IP address. Some methods use the server only when establishing the connection (such as Simple Traversal of UDP through NATs (generally abbreviated as ‘STUN’)). Other known methods are based on relaying all the data through it (such as ‘TURN’), which adds bandwidth costs and increases latency, which are detrimental to real-time VoIP applications.

STUN is a standards-based network protocol used as one of the methods of NAT traversal in applications of real-time voice, video, messaging, and other interactive IP communications. The STUN protocol allows applications operating through a NAT to discover the presence and specific type of NAT, and obtain the mapped (public) IP address (NAT address) and port number that the NAT has allocated for the application's User Datagram Protocol (UDP) connections to remote hosts. The protocol requires assistance from a 3rd-party network server (STUN server) located on the opposing public site of the NAT, usually the public Internet. The protocol is defined in RFC 3489.

As defined in TR-069 Annex G, a proposal has been made to use a STUN Service capability to facilitate the addressing of a CPE behind a Firewall/NAT Gateway and request Connection to the ACS.

Here, Binding Requests are used to maintain a ‘heartbeat’ between the CPE and the STUN Server to maintain TR-069 Communication. The FAP has to maintain a second heartbeat mechanism to the FGW for Voice/Data Signalling Communication.

When a STUN Server is required for connection establishment to the CPE, then the ACS sends user datagram protocol (UDP) Connection Request Messages to the STUN Server, whereby these UDP messages do not use digest-authentication.

The security authentication between the ACS and CPE for the STUN Server solution is a proprietary arrangement, rather than based on a standardardised solution, such as digest-authentication, because UDP Connection requests are mandated towards a STUN Server, and is documented in the Broadband Forum Specification for adoption by all ACS and CPE vendors.

The unique identifier of the CPE on the STUN Server is a username, not a serial number, thereby adding a further complication to username management on the ACS. This use of a unique identifier of the CPE also complicates the ability to support multiple TR-069 Servers requiring connectivity.

When a STUN Server is not required for connection establishment to the CPE, then the ACS sends a hyper text transfer protocol (HTTP) Connection Request Message directly to the CPE using digest-authentication. Here, the HTTP Connection Request Message sent from the ACS uses digest authentication and a URL provided by the CPE, which contains a URL or IP-address with port number.

The HTTP Connection Request Message proposes the use of a query string with the URL to carry the timestamp, message ID, cnonce value, username, and signature (encrypted using the password). As will be appreciated, the cnonce value must be specified if a qop directive is sent, and must not be specified if the server did not send a qop directive in the WWW-Authenticate header field. The cnonce-value is an opaque quoted string value provided by the client and used by both client and server to avoid chosen plaintext attacks, to provide mutual authentication, and to provide some message integrity protection.

The TR-069 system only allows the connection to one TR-069 ACS Server as the connection request does not provide differentiation of different servers requesting access. The inventor of the present invention has recognized an additional need to overcome a limitation of the current TR-069 Specification and allow different TR-069 Servers to request connection to both the ACS and an Element Management System (EMS) of the FAP.

It is known that hyper text transport protocol (HTTP) intermediary servers are able to capture the connection request messages and replay them, thereby causing service issues. The server receiving the connection requests can look at the digest-authentication information and also can be configured to limit the number of connection requests allowed within a predefined period. The limiting of the number of connection requests allowed within a predefined period is generally referred to as the so-called ‘denial of service attacks’. The ‘denial of service attacks’ in the TR-069 standard are also managed at the FAP level. Thus, it is envisaged that Connection requests and denial of service attacks, as defined in the current TR-069 standard, may eventually flood the FGW with unnecessary connection requests, which are likely to become a performance impacting problem on the FGW when supporting larger FAP numbers.

Thus, a need exists for an improved method and apparatus for provision of connection requests in a cellular communication network.

### SUMMARY OF THE INVENTION

Accordingly, the invention seeks to mitigate, alleviate or eliminate one or more of the abovementioned disadvantages, singly or in any combination.

A network element, a communication access point, an integrated circuit and a method of connection to a server are described as defined in the accompanying Claims.

These and other aspects, features and advantages of the invention will be apparent from, and elucidated with reference to, the accompanying dependent Claims and the embodiments described hereinafter.

### BRIEF DESCRIPTION OF THE DRAWINGS

Embodiments of the invention will be described, by way of example only, with reference to the accompanying drawings, in which:

FIG. 1A and FIG. 1B illustrate a known proposed mechanism for provisioning a 3G AC and a 3G AP in a femto cell network.

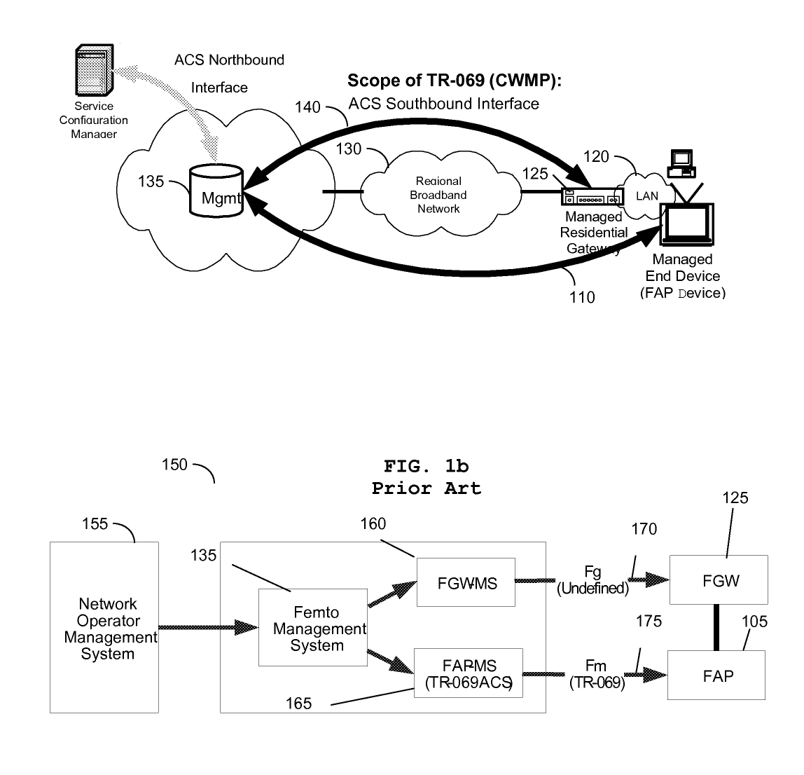

FIG. 2 illustrates a cellular-based architecture adapted to implement embodiments of the invention.

FIG. 3 a message sequence chart for provisioning an ACS Connection Request sent from the TR-069 ACS via the FGW, in accordance with some embodiments of the invention.

FIG. 4 illustrates an ACS Connection Request sent from the TR-069 ACS via the FGW, adapted in accordance with some embodiments of the invention.

FIG. 5 illustrates a typical computing system that may be employed to implement signal processing functionality in embodiments of the invention.

### DETAILED DESCRIPTION OF EMBODIMENTS OF THE INVENTION

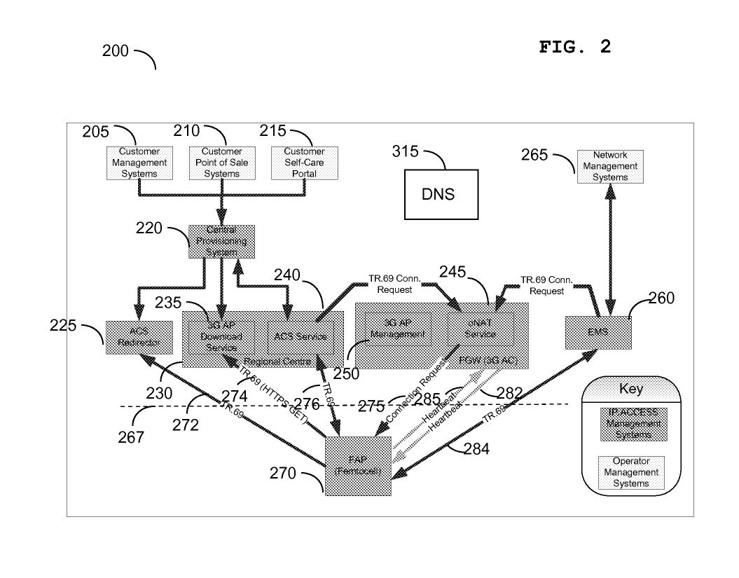

FIG. 2 illustrates a cellular-based architecture 200 adapted to implement embodiments of the invention. The cellular-based architecture 200 comprises a plurality of customer systems, for example customer management system 205, customer point of sales systems 210 and customer self-care portal systems 215, operably coupled to a central provisioning system 220 of the cellular-based architecture 200. The central provisioning system 220 is operably coupled to an ACS re-director 225, a regional centre 230 and a femto cell gateway, for example a 3G access controller (3G AC) 245. These three logic modules/systems may, in turn, be operably coupled to a femto cell access point (FAP) 270 for routing communications to a communication device, such as an user equipment (UE). The ACS re-director 225 is operably coupled to the FAP 270 via a TR69 communication link 272.

In accordance with one embodiment of the invention, the regional centre 230 comprises a 3G AP download service logic module 235 and an ACS service logic module 240. In accordance with embodiments of the invention, the 3G AP download service logic module 235 is operably coupled to the FAP 270 via a TR69 (HTTPS GET) communication link 274. In accordance with embodiments of the invention, the ACS service logic module 240 is operably coupled to the FAP 270 via a TR69 communication link 276.

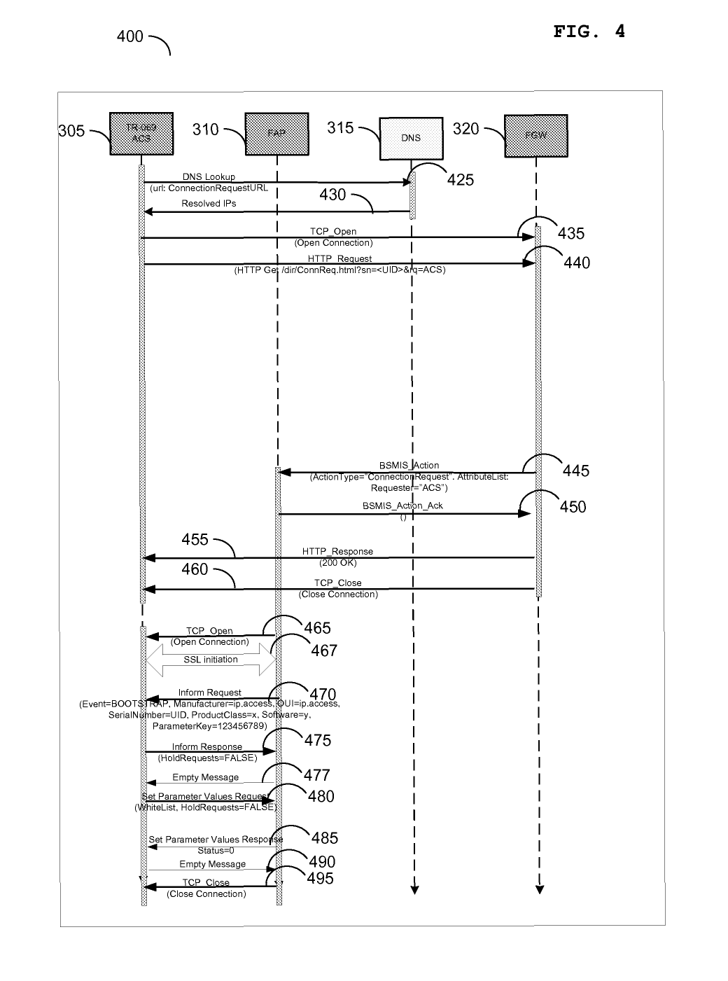

In accordance with one embodiment of the invention, the FGW 245 comprises a 3G AP Management logic module 250 and an oNAT service logic module 255. In accordance with embodiments of the invention, the oNAT service logic module 255 is operably coupled to the FAP 270 via a Connection Request communication link 275, which in FIG. 4 is a BSMIS_Action Message 445, but in 3GPP could be an HNBAP Message.

Notably, in accordance with embodiments of the invention, the oNAT service logic module 255 is also operably coupled to the ACS service logic module 240 and an Element Management System (EMS) 260 associated the FAP 270 via TR69 Connection Request communication links. The EMS 260 is also operably coupled to the FAP 270 via a TR69 communication link 284. The EMS 260 is also operably coupled to the external network, such as a Network Management System 265, as shown.

Two heartbeats 280, 282 are shown between the FAP 270 and FGW 245.

The inventor of the present invention has recognized an additional need to overcome a limitation of the current TR-069 Specification and allow different TR-069 Servers to request connection to both the ACS Service logic module 245 and the EMS 260 of the FAP 270. For example, it is envisaged that these additional connections will be able to transport alarms over TR-069 to an EMS system, such as EMS 260, which is different to the TR-069 ACS Server logic module 240 that provides provisioning only.

In operation, the FGW 245 already supports NAT Traversal for Voice/Data signalling between the femto cell FAP 270 and the FGW 245. Therefore, the existing capabilities of the FGW 245 have been re-used and enhanced by replicating some operations of a TR-069 STUN Server, thereby precluding the need to implement additional STUN capability on both the CPE and ACS Service. The FGW 245 comprises a processing logic module (not shown) adapted to accept a connection request from the ACS Server 240 and then send a connection request to the FAP 270. The FAP 270 also has a processing logic module (not shown) adapted to receive this request from the FGW 245 and connect to the ACS Service 240.

The FAP 270 also manages the connection request address allocation for the ACS Service 240 and EMS 260 and automatically notifies them of any ConnectionRequestURL change.

Embodiments of the invention propose a solution that allows the differentiation and authentication of different requesting TR-069 Servers. In the provisioning and inclusion of the serial number and requestor type information, to be included in the query string of the URL defined by the FAP 270 and used in formulating the HTTP Connection Request sent to the ACS Server 240 or EMS 260, it is possible to differentiate between ACS Servers 240. In particular, the FGW 245 is able to validate the username and password passed from the TR-069 ACS Server 240 in the connection request, before sending an Action message to the FAP 270 requesting a connection to a particular TR-069 ACS Server.

The proposed architecture 200 is arranged to allow the differentiation and authentication of different requesting TR-069 Servers (not shown). Here, the FAP 270 is adapted to create different Connection Request URLs for the EMS 260 and the TR-069 ACS 240, which distinguish the entity that is requesting connection using the Requestor ID. Therefore, when a HTTP connection request is sent to the FGW 245 (from the ACS) the oNAT Service logic module 255 validates the username/password associated with the Requestor and sends a request via 275 requesting that the FAP connects to either the EMS 260 or TR-069 Server 255.

In this manner, by provision of an adapted oNAT Service logic module 255, a CPE such as a UE that is located behind a Firewall/NAT 267 is allowed access to the network without a need to deploy a separate and additional BroadBand Forum defined STUN Server. In effect, the ACS Server 240 believes that it is sending the connection request directly to the CPE because the FAP 270 has the ability to manage and change the ConnectionRequestURL used by the ACS Server 240 without any functionality change required on the ACS Server 240.

Thus, the ACS Server 240 is arranged to send an HTTP Connection request Message with digest-authentication to the oNAT Service logic module 255 of the FGW 245, which advantageously adds a standard security mechanism layer between the ACS Server 240 and the FGW 245.

Thus, by using HTTP Connection request messages directed to the FGW 245, embodiments of the invention enable the standard digest-authentication mechanism to be advantageously used for connection request validation by the FGW 245 and FAP 270.

In one embodiment of the invention, it will be appreciated that certain CPE devices will already have a signaling connection to the Service Hosting Network Element (e.g. FGW), for example to use 3GPP Services such as voice and/or data traffic. Thus, the FGW 245 maintains a persistent communication link to the FAP 270 through the Firewall/NAT 267. Therefore, rather than maintaining a separate STUN-based communication channel, the management connection requests sent to the FGW 245, according to embodiments of the invention, benefit from re-using the existing HTTP Connection request Message from the FGW 245 to the FAP 270.

Embodiments of the invention propose a solution whereby the oNAT Service provides the ability to cope with Denial of Service Attacks at the FGW level, thereby allowing the FAP to continue service relatively unimpacted. Thus, in particular, embodiments of the invention provide the ability for the FGW 245 to detect and prevent Denial of Service of Attacks by checking against replaying of HTTP Connection Request Messages by an external intermediary source. The oNAT Service achieves this capability by checking the digest-authentication contained within the HTTP Connection Request Messages, which are not present in the existing STUN Server UDP Connection Messages, as well as supporting the ability to throttle the number of connection requests within a pre-defined time period.

Embodiments of the invention propose a solution that defines an intelligent retry mechanism to allow the ACS to restrict the number of Connection requests for a particular FAP. Advantageously, this mechanism reduces the signaling load with respect to Connection requests and determining when to send new connection requests based on HTTP Response Status Codes. The retry mechanism is achieved by the FGW 245 sending back different HTTP Status Codes with an optional retry-after value to the ACS Server 240 as a result of an HTTP Connection request, which allows the ACS Server 240 to determine if and when an GTTp Connection request should be re-tried.

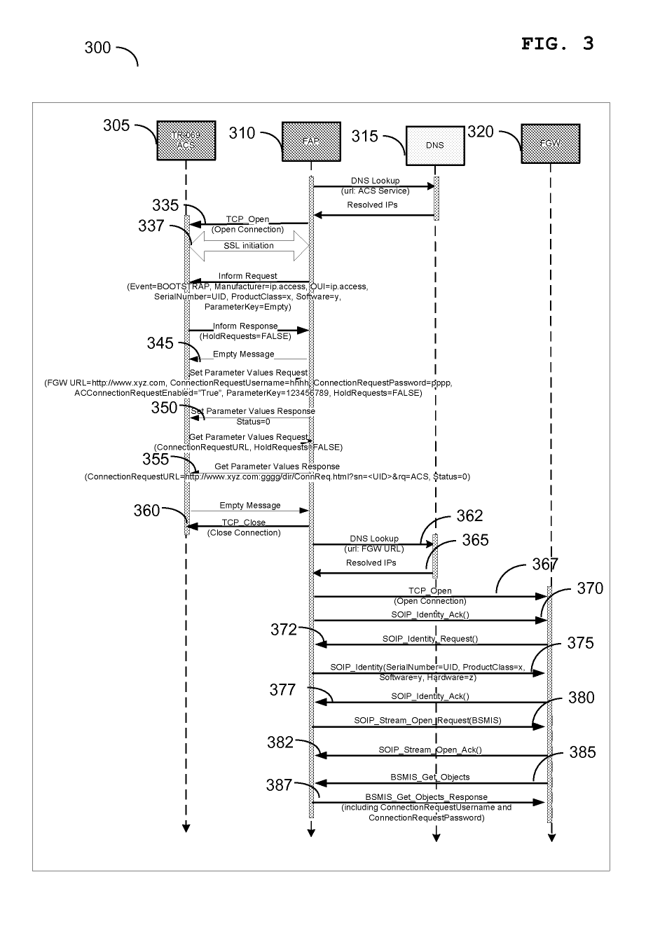

Referring to FIG. 3 there is illustrated a message sequence chart 300 showing a TR-069 ACS Connection Request via the FGW, adapted in accordance with embodiments of the invention. The message sequence chart 300 illustrates communications that are passed between a TR-069 ACS 305, a femto cell access point (FAP) 310, a domain name server (DNS) 315 and a femto cell gateway (FGW). The message sequence chart 300 commences with a DNS lookup message incorporating the uniform resource locator (URL) of the ACS Service being sent from the FAP 305 to the DNS 315, as shown in step 325. The DNS 315 returns a message to the FAP 310 with the resolved IP Addresses of the TR-069 ACS 305, as shown in step 330.

In response thereto, the FAP 310 opens a transport communication protocol connection with a ‘TCP Open’ message sent to the TR-069 ACS 305, as shown in step 335. Thereafter, a Secure Sockets Layer (SSL) communication channel between the TR-069 ACS 305 and the FAP 310 is created, as shown in step 337. Subsequently, the FAP 310 sends an Inform Request message to the TR-069 ACS 305, as shown in step 340. In one embodiment of the invention, the Inform Request message comprises field information, such as: ‘Event=Bootstrap’, ‘Manufacturer=ip.access’, ‘OUI=ip.access’, ‘serial/number=UID’, ‘productclass=x’, ‘software=y’, ‘parameterkey=empty’.

In response to the Inform Request message the TR-069 ACS 305 replies to the FAP 310 with an Inform response message, for example comprising a ‘Holdrequests=FALSE’ indication, as shown in 342. The FAP 310 then responds with an ‘Empty message’ as shown in step 345. In response, according to embodiments of the invention, the TR-069 ACS 305 replies to the FAP 310 with a ‘Set parameter values’ request message with the FGW 320 URL and ConnectionRequestEnabled, as shown in step 347. Advantageously, and notably, this results in the FAP 310 is able to calculate a connection Request URL that is retrieved by the Tr-069 ACS 305. Based on this message, the FAP 270 receives a Set parameter values response message as in step 350.

Similarly, in response, the TR-069 ACS 305 replies to the FAP 310 with a ‘Get parameters Values Request’ message, as shown in step 352, based on which it receives a ‘Get Parameter Values Response’ message as in step 355. An ‘Empty message’ is then sent from the TR-069 ACS 305 to the FAP 310 as shown in step 357, and in response thereto, the FAP 310 closes the TCP connection with a TCP Close message, as shown in step 360.

The above TR-069 messaging sequence allows the transferal and setup of the ConnectionRequestURL from the FAP 310 to the ACS 305, for use by the ACS 305 for future sending of HTTP Connection Requests 440.

Once the provisioning operation has been completed, the message sequence chart 300 then proceeds with a DNS lookup message incorporating the URL of the FGW being sent from the FAP 305 to the DNS 315, as shown in step 362. The DNS 315 returns a message to the FAP 310 with the resolved IP Addresses of the FGW 320, as shown in step 365.

In response thereto, the FAP 310 opens a transport communication protocol connection with a ‘TCP Open’ message sent to the FGW 320, as shown in step 367. In addition, the FAP 310 sends a ‘Signalling over IP framework (SoIP) SOIP_idenity_Ack’ to the FGW 320 which confirms the FGW 320 is trusted by the FAP 310, as shown in step 370. In response thereto, the FGW 320 sends a ‘SOIP_identity_request’ message to the FAP 310 which is requesting that the FAP 310 provides identifying information for validation, as shown in step 372. The FAP 310 then sends its SOIP Identity message to the FGW 320, comprising for example SOIP_Identity (SerialNumber=UID, ‘serial/number=UID’, ‘productclass=x’, ‘software=y’, ‘hardware=z’) which is the information required by the FGW 320 to validate the FAP 310 and check the software/hardware versions, as shown in step 375.

In response thereto, the FGW 320 sends a ‘SOIP_identity_ACK’ message to the FAP 310 to indicate to the FAP 310 that the FGW 320 has accepted the establishment of a connection to the FAP 310, as shown in step 377. The FAP 310 then sends its SOIP_Stream_Open_Request(BSMIS) message to the FGW 320 to open a Management Signalling Stream, as shown in step 380. In response thereto, the FGW 320 sends a ‘SOIP_stream_Open_ACK’ message to the FAP 310 to acknowledge the establishing of the Management Signalling Stream, as shown in step 382. The FGW 320 also sends a ‘BSMIS_Get_Objects’ message to the FAP 310 to request the supplying of FAP Information from the FAP 310, as shown in step 385. The FAP 310 then sends its ‘BSMIS_Get_Objects_Response’ message to the FGW 320, which comprises, for example, ConnectionRequestUsername and ConnectionRequestPassword information, as shown in step 387. This information is used by the FGW 320 in subsequent message sequences to validate the username and passwords contained in the subsequent HTTP Connection request Message 440.

Referring now to FIG. 4 there is illustrated a message sequence chart 400 that is a continuation of the message sequence chart 300 of FIG. 3, to explain an exemplary embodiment of the first ACS Connection Request sent from the TR-069 305 via the FGW 320.

The message sequence chart 400 commences with a DNS lookup message incorporating the uniform resource locator (URL) of the ConnectionRequest being sent from the TR-069 ACS 305 to the DNS 315, as shown in step 425. The DNS 315 returns a message to the TR-069 ACS 305 with the resolved IPs of the FGW 320, as shown in step 430.

In response thereto, the TR-069 ACS 305 opens a transport communication protocol connection with a ‘TCP Open’ message sent to the FGW 320, as shown in step 435. In accordance with embodiments of the invention, the TR-069 ACS 305 also sends a HTTP Request message to the FGW 320, for example of the form:

‘HTTP Get/dir/ConnReq.html?sn=<UID>&rq=ACS’, as shown in step 440. The FGW 320 uses the FAP's calculated ConnectionrequestURL and the FGW 320 is able to handle the digest authentication. The FGW 320 subsequently then sends a connection request to the FAP 310 via the signaling layer between the FGW 320 and the FAP 370, in a ‘BSMIS_Action’ message, for example comprising the field: (ActionType=‘ConnnectionRequest.AttributeList: Requestor=“ACS”), as shown in step 445. The FAP 310 then sends its ‘BSMIS_Action_Ack’ message to the FGW 320, as shown in step 450. In response thereto, the FGW 320 sends a HTTP_Response message to the TR-069 ACS 305, as shown in step 455, together with a close connection ‘TCP_Close’ message as shown in step 460.

In response thereto, the FAP 310 opens a transport communication protocol connection with a ‘TCP Open’ message sent to the TR-069 ACS 305, as shown in step 465. Thereafter, a Secure Sockets Layer (SSL) communication channel between the TR-069 ACS 305 and the FAP 310 is created, as shown in step 467. Subsequently, the FAP 310 sends an Inform Request message to the TR-069 ACS 305, as shown in step 470. In one embodiment of the invention, the Inform Request message comprises field information, such as: ‘Event=Bootstrap’, ‘Manufacturer=ip.access’, ‘OUI=ip.access’, ‘serial/number=UID’, ‘productclass=x’, ‘software=y’, ‘parameterkey=123456789’.

In response to the Inform Request message the TR-069 ACS 305 replies to the FAP 310 with an Inform response message, for example comprising a ‘Holdrequests=FALSE’ indication, as shown in 475. The FAP 310 then responds with an ‘Empty message’ as shown in step 477. In response, the TR-069 ACS 305 replies to the FAP 310 with a ‘Set parameter values’ request message, for example comprising (WhiteList, Holdrequests=FALSE’ indication) as shown in step 480, based on which it receives a Set parameter values response message (with Status=0) as in step 485.

An ‘Empty message’ is then sent from the TR-069 ACS 305 to the FAP 310 as shown in step 490, and in response thereto, the FAP 310 closes the TCP connection with a TCP Close message, as shown in step 495.

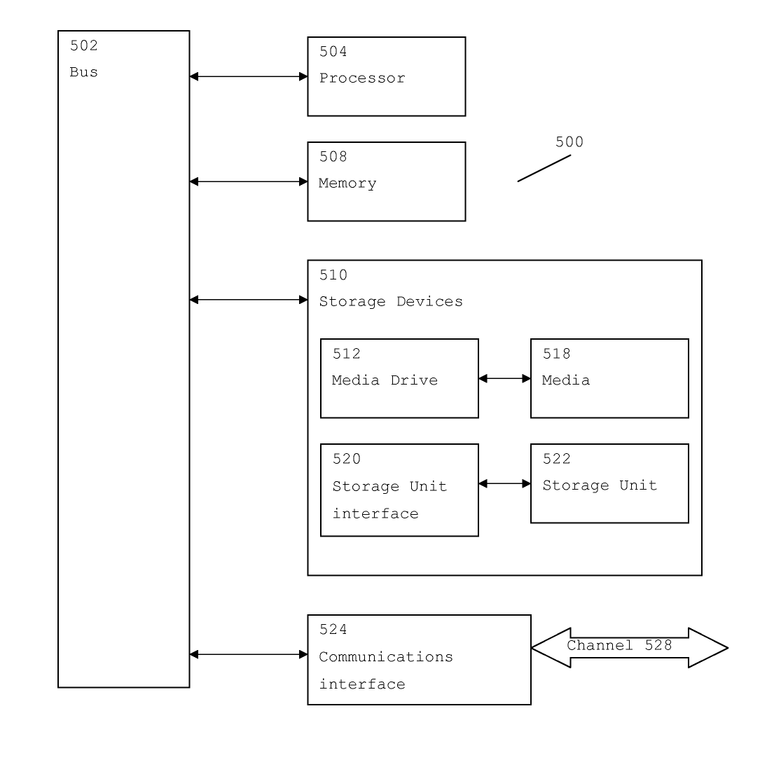

Referring now to FIG. 5, there is illustrated a typical computing system 500 that may be employed to implement signal processing functionality in embodiments of the invention. Computing systems of this type may be used in access points and wireless communication units. Those skilled in the relevant art will also recognize how to implement the invention using other computer systems or architectures. Computing system 500 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 500 can include one or more processors, such as a processor 504. Processor 504 can be implemented using a general or special-purpose processing engine such as, for example, a microprocessor, microcontroller or other control logic. In this example, processor 504 is connected to a bus 502 or other communications medium.

Computing system 500 can also include a main memory 508, such as random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (ROM) or other static storage device coupled to bus 502 for storing static information and instructions for processor 504.

The computing system 500 may also include information storage system 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 518 may include, for example, a hard disk, floppy disk, magnetic tape, optical disk, CD or DVD, or other fixed or removable medium that is read by and written to by media drive 512. As these examples illustrate, the storage media 518 may include a computer-readable storage medium having particular computer software or data stored therein.

In alternative embodiments, information storage system 510 may include other similar components for allowing computer programs or other instructions or data to be loaded into computing system 500. Such components may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a universal serial bus (USB) port), a PCMCIA slot and card, etc. Software and data transferred via communications interface 524 are in the form of signals which can be electronic, electromagnetic, and optical or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 508, storage device 518, or storage unit 522. These and other forms of computer-readable media may store one or more instructions for use by processor 504, to cause the processor to perform specified operations. Such instructions, generally referred to as ‘computer program code’ (which may be grouped in the form of computer programs or other groupings), when executed, enable the computing system 500 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 500 using, for example, removable storage drive 522, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional elements and processors. However, it will be apparent that any suitable distribution of functionality between different functional elements or processors, for example with respect to the access point or controller, may be used without detracting from the invention. For example, it is envisaged that functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although one embodiment of the invention describes an access point for a UMTS network, it is envisaged that the inventive concept is not restricted to this embodiment.

It is envisaged that the aforementioned inventive concept aims to provide at least one or more of the following advantages:

One provisioning Interface, which removes Femto/3G AP and 3G AC data misalignment;

(ii) The 3G femto cell AP acts as an Intelligent Residential Gateway and provisions the 3G AC with the 3G femto cell AP required information for service, which is similar to DSL Provisioning Architectures for upstream systems via the CPE

(iii) Reduced capital expenditure and operating costs due to the reduced number of femtocell Management applications and interfaces required to be defined, developed, integrated, and supported.

(iv) Direct provisioning of APs is better for scalability, as there is only one entity to provision, thereby resulting in a reduced operational expenditure as well reduces the size of the management system, and hence capital expenditure.

(v) Not having to provision ACs alongside APs is better for both scalability and data synchronisation.

(vi) Enabling more efficient use of resources when implementing provision of information on a cellular basis.

Although the invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Moreover, an embodiment can be implemented as a computer-readable storage element having computer readable code stored thereon for programming a computer (e.g., comprising a signal processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’ etc. do not preclude a plurality.

Thus, a method and apparatus for provisioning of information in a cellular communication network have been described, which substantially addresses at least some of the shortcomings of past and present access control techniques and/or mechanisms.

1. A network element comprises a translator service logic module arranged to be operably coupled to each of:
a communication access point via a first communication link;
an auto configuration server, ACS, logic module via a second communication link; and
an Element Management System, EMS, associated with the communication access point via a third communication link;
wherein the translator service logic module is arranged to receive a TR-069 hyper text transport protocol (HTTP) connection request from the ACS logic module, translate the TR-069 hyper text transport protocol (HTTP) connection request to a BSMIS Action message or an HNBAP message, and transmit the BSMIS Action message or an HNBAP message to the communication access point via the first communication link.

2. (canceled)

3. (canceled)

4. The network element of claim 1 wherein the communication access point is a femto cell access point.

5. The network element of claim 1 wherein the second and third communication links are TR69 Connection Request communication links.

6. The network element of claim 1, wherein the communication access point is arranged to manage a connection request address allocation for either the ACS logic module or EMS and automatically notify the recipient of any change to the connection request.

7. The network element of claim 6 wherein the change to the connection request is a change to a uniform resource locator, URL, of the connection request.

8. The network element of claim 1 wherein the translator service logic module is arranged to include a serial number and a requestor type in the connection request sent to the communication access point.

9. The network element of claim 8 wherein the serial number and the requestor type are included in a query string of a uniform resource locator, URL, defined by the communication access point.

10. The network element of claim 1 wherein the translator service logic module is arranged to validate at least one selected from the group consisting of: a username and a password, sent from the ACS logic module in the connection request.

11. The network element of claim 1 wherein the ACS logic module is arranged to send an HTTP connection request message with digest-authentication to the translator service logic module.

12. The network element of claim 11 wherein the translator service logic module is arranged to check the digest-authentication contained within the HTTP connection request message.

13. A communication access point arranged to be operably coupled to each of:
a network element comprising a translator service logic module via a first communication link;
an auto configuration server, ACS, logic module via a second communication link; and
an Element Management System, EMS, associated with the communication access point via a third communication link;
wherein the communication access point comprises a logic module arranged to receive a connection request from the ACS logic module via the translator service logic module and connect to an identified ACS logic module or an identified EMS in response to the connection request, wherein the logic module is arranged to create different connection request URLs for the identified EMS and the identified ACS logic module.

14. (canceled)

15. The communication access point of claim 13 wherein the communication access point is a femto cell access point.

16. A semiconductor device for a network element of a communication system, the semiconductor device comprising:
a translator service logic module arranged to be operably coupled to each of: a communication access point via a first communication link, an auto configuration server, ACS, logic module via a second communication link, and an Element Management System, EMS, associated with the communication access point via a third communication link;
wherein the translator service logic module is arranged to receive a TR-069 hyper text transport protocol (HTTP) connection request from the ACS logic module, translate the TR-069 hyper text transport protocol (HTTP) connection request to a BSMIS Action message or an HNBAP message, and transmit the BSMIS Action message or an HNBAP message to the communication access point via the first communication link.

17. A communication system comprising the network element of claim 1.

18. A semiconductor device for a communication access point comprising a logic module arranged to be operably coupled to:
a network element comprising a translator service logic module via a first communication link;
an auto configuration server, ACS, logic module via a second communication link; and
an Element Management System, EMS, associated with a communication access point via a third communication link;
wherein the logic module is arranged to receive a connection request from the ACS logic module via the translator service logic module and connect to an identified ACS logic module or an identified EMS in response to the connection request, wherein the logic module is arranged to create different connection request URLs for the identified EMS and for the identified ACS logic module.

19. A communication system comprising the communication access point of claim 15.

20. A method for making a connection request in a communication system comprising a network element that comprises a translator service logic module coupled: to a communication access point via a first communication link, to an auto configuration server, ACS, logic module via a second communication link, and to an Element Management System, EMS, associated with the communication access point via a third communication link,
wherein the method comprises:
receiving a TR-069 hyper text transport protocol (HTTP) connection request from the ACS logic module at the translator service logic module;
translating the TR-069 hyper text transport protocol (HTTP) connection request to a BSMIS Action message or an HNBAP message; and
transmitting the BSMIS Action message or an HNBAP message to the communication access point via the first communication link.

21. A non-transitory computer program product having executable code stored therein for programming signal processing logic module to perform a method for making a connection request in a communication system comprising a translator service logic module coupled to each of: a communication access point via a first communication link, an auto configuration server, ACS, logic module via a second communication link, and an Element Management System, EMS, associated with the communication access point via a third communication link;
wherein the program code is operable for when executed at a network element:
receiving a TR-069 hyper text transport protocol (HTTP) connection request from the ACS logic module at the translator service logic module;
translating the TR-069 hyper text transport protocol (HTTP) connection request to a BSMIS Action message or an HNBAP message; and
transmitting the BSMIS Action message or an HNBAP message to the communication access point via the first communication link.

22. The computer-readable storage element of claim 21, wherein the computer-readable storage element comprises at least one of a hard disk, a CD-ROM, an optical storage device, a magnetic storage device, a Read Only Memory, ROM, a Programmable Read Only Memory, PROM, an Erasable Programmable Read Only Memory EPROM, EPROM, an Electrically Erasable Programmable Read Only Memory, EEPROM, and a Flash memory.
